(19) United States
(12) Patent Application Publication
(10) Pub. No.: US 2015/0301873 A1
(43) Pub. Date: Oct. 22, 2015

(54) METHOD AND SYSTEM FOR EXPANDING WEBAPP APPLICATION FUNCTION

(71) Applicant: GUANGZHOU UCWEB COMPUTER TECHNOLOGY CO., LTD, Guangzhou, Guangdong (CN)

(72) Inventors: Jie Liang, Guangdong (CN); Yongfu Yu, Guangdong (CN); Xiaopeng He, Guangdong (CN); Shunyan Zhu, Guangdong (CN); Miaokui Ma, Guangdong (CN)

(21) Appl. No.: 14/440,859

(22) PCT Filed: Sep. 6, 2013
(86) PCT No.: PCT/CN2013/083037

§ 371 Date: May 5, 2015

(30) Foreign Application Priority Data
Nov. 7, 2012 (CN) 201210442145.8

(51) Int. Cl. G06F 9/54

(52) U.S. Cl. CPC G06F 9/541; G06F 9/542

(57) ABSTRACT

A method and system for expanding a WebApp application function. The method comprises: adding a function expansion field which contains an expansion JS function and an address of a local application which responds to a request of the expansion JS function in the WebApp; sending each parameter of the function to a browser kernel by calling the expansion JS function; a WebApp frame setting an address of a local application program as the address of the local application which responds to the request of the expansion JS function according to a calling message received by the browser kernel; activating a target application program specified by the address according to the address of the local application; the activated target application program executing the expansion JS function according to the parameters of the expansion JS function and returning an execution result to the WebApp.

### FIELD

The present invention relates to the technical field of mobile communications, and more particularly, relates to a method and system for extended WebApp (network application) application functions.

### BACKGROUND

WebApp refers to Web-based (network) systems and applications, and browser-based web applications developed on the HTML (Hypertext Markup Language, HTML) 5 standard. WebApp publishes a complex set of content and functionality to the majority of end-users. Currently, many browser vendors implement a WebApp framework for installing WebApp in the browser, in order to achieve the expansion capabilities of the browser.

However, the functions achieved by the WebApp are all provided by WebApp framework, and the functions provided by the WebApp framework are only provided by the browser. Thus, WebApp can't use the functionality browsers don't provide, resulting in functional limitations. This greatly limits the development space of WebApp. FIG. 1 shows how browsers limit WebApp.

However, currently many applications are available and they can perform a lot of functions. It is very unrealistic if the platform-specific functionality completely depends on browser vendors to achieve. After all, browser vendors are unable to support them all, performance can be worse than for native applications, and may result in bugs.

Therefore, how to make WebApp directly use functionality of other applications installed on the operating system has become a problem in browser-based network applications.

### BRIEF SUMMARY

In view of the above problems, an object of the invention is to provide a method and system for expanding WebApp application functions so that the Webapp can directly use the functions of other applications installed on the operating system.

One aspect of the present invention may include a method of expanding WebApp application functions, comprising: adding a function expansion field which contains an expansion JS function and an address of a local application which responds to a request of the expansion JS function in the WebApp;

Sending each parameter of the function to a browser kernel by calling the expansion JS function;

A WebApp frame setting an address of a local application program as the address of the local application which responds to the request of the expansion JS function according to a calling message received by the browser kernel;

Activating a target application program specified by the address according to the address of the local application;

The activated target application program executing the expansion JS function according to the parameters of the expansion JS function and returning an execution result to the WebApp.

Another aspect of the present invention may include a system for expanding WebApp application functions, including: a configuration unit of a function expansion field, configured to add a function expansion field which contains an expansion JS function and an address of a local application which responds to a request of the expansion JS function in the WebApp;

A calling unit of an expansion function, configured to call the expansion JS function and send each parameter of the function to a browser kernel by calling the expansion JS function;

A locking unit of a local application, configured to set an address of a local application program as the address of the local application which responds to the request of the expansion JS function according to a calling message received by the browser kernel;

An activation unit of a local application, configured to activate a target application program specified by the address according to the address of the local application;

An execution unit of an expansion function, configured by the activated target application program to execute the expansion JS function according to the parameters of the expansion JS function and return an execution result to the WebApp.

Another aspect of the invention may include a method of expanding Webapp applications comprising adding a function expansion field in the Webapp, wherein the function expansion field contains an expansion JS function and an address of a target application which responds to a request of the expansion JS function, wherein the method comprises:

When the WebApp calls the expansion JS function, sending the parameters of the expansion JS function to the target application program the address of the target application points to;

Executing the target application program according to the parameters of the expansion JS function, and returning an execution result to the WebApp.

Wherein sending the parameters of the expansion JS function to the target application program the address of the target application points to further comprises:

By calling the expansion JS function, sending the parameters of the expansion JS function to a browser kernel;

Notifying a WebApp frame of the parameters of the expansion JS function through the browser kernel;

Sending the parameters of the expansion JS function through the WebApp frame to a target application program the address points to.

Wherein returning the execution result to the WebApp comprises:

Returning the execution result to the WebApp frame through the target application program;

Providing the execution result as a return value of the expansion JS function to the WebApp through the WebApp frame.

Wherein the WebApp frame uses the Intent to send the parameters of the expansion JS function to the target application program the address points to;

The target application program returns the execution result to the WebApp frame.

Wherein the service executed by the target application program is with or without an interface

Wherein the function expansion field is added in the configuration file of a WebApp installation package.

Wherein a package name, a class name, or a system protocol of the target application program is the address of the target application program.

Another aspect of the present invention may include a system for expanding WebApp applications, adding a function expansion field in the WebApp, wherein the function expansion field contains an expansion JS function and an address of a target application program which responds to a request of the expansion JS function. The system comprises:

A transmission unit configured to send the parameters of the expansion JS function to the target application program the address of the target application program points to when the WebApp calls the expansion JS function;

A program execution unit configured to execute the target application program according to the parameters of the expansion JS function and returning the execution result to the WebApp.

Wherein the transmission unit comprises:

A function calling subunit, configured to send the parameters of the expansion JS function to a browser kernel by calling the expansion JS function;

A kernel running subunit, configured to notify the WebApp frame of the parameters of the expansion JS function through the browser kernel

A first frame running subunit, configure to send the parameters of the expansion JS function to the target application program the address points to through the WebApp frame.

Wherein the program running unit comprises:

A program execution subunit, configured to return the execution result to the WebApp frame through the target application program;

A second frame running subunit configured to provide the execution result as the return value of the expansion JS function to the WebApp through the WebApp frame.

Another aspect of the invention may include a computer-readable medium that includes processor executable program code. When executed, the program code configures the processor to perform the steps of:

Adding a function expansion field in a WebApp that contains an expansion JS function and an address of a target application program which responds to a request of the expansion JS function;

When the WebApp calls the expansion JS function, sending the parameters of the expansion JS function to the target application program the address of the target application program points to;

Executing the target application program according to the parameters of the expansion JS function and returning the execution result to the WebApp.

According to the aforementioned invention, the method and system for expanding WebApp application functions allow a WebApp to be directly used in other application functions installed on the operating system, (as long as the corresponding applications have been installed on the operating system), to call the functions of the other applications, which greatly extends the capabilities of the WebApp by allowing the WebApp to be used in other applications installed on the operating system other than a browser, and thus there is no need of a browser to expand each of them.

The aspect of greatly extending the capabilities of the WebApp is reflected in the following: the WebApp can achieve some functions by a local application that some browsers cannot offer or temporarily do not provide, because the WebApp can visit these applications by a package name and use the features they provide. For example, some of the new provisions of the HTML 5 is specified: Battery API (e.g., an Application Programming Interface), orientation sensor, etc., if the browser does not provide such functionality, then the WebApp can achieve these functions, because it can use other applications locally installed and possessing these functions to get the battery power and the data of the current orientation sensor.

To achieve the foregoing and related ends, one or more aspects of the present invention may include those features described later in detail and particularly pointed out in the claims. The following description and the accompanying drawings indicate certain illustrative aspects of the present invention. However, these aspects are indicative only some of all the principles of practicing the present invention. In addition, the invention is intended to include all such aspects and their equivalents

### BRIEF DESCRIPTION OF THE DRAWINGS

In order to more clearly illustrate the embodiments or technical examples in the prior art, the embodiments or the accompanying drawings used for describing the prior art are briefly introduced as below. In the following description, the drawings are only some embodiments of the present invention. To those of ordinary skill, modifications will be readily apparent based on these drawings.

Consulting with the descriptions of the accompanying drawings and the contents of the claims and with a better understanding of the present invention, other objects and results of the present invention will become more apparent and easy to understand. In the drawings:

FIG. 1 is a schematic drawing of the restrictions of a browser on a WebApp in the prior art;

FIG. 2 is a schematic flow diagram of a method for expanding WebApp application functions according to some embodiments;

FIG. 3 is a schematic flow diagram of a method for expanding WebApp application functions according to some embodiments;

FIG. 4 is a schematic drawing of a system for expanding WebApp application functions according to some embodiments;

FIG. 5 is a schematic flow diagram of a method for expanding WebApp application functions according to some embodiments; and

FIG. 6 is a schematic view of a system for expanding WebApp application functions according to some embodiments.

Throughout the drawings the same reference numerals indicate similar or corresponding features or functions

### DETAILED DESCRIPTION

In order to enable persons skilled in the art to better understand the technical solutions in the embodiment s, and make the above-mentioned objects, features and advantages described in the embodiment of the present invention more fully and easily understood, the technical solution is further described in detail in the following in conjunction with the accompanying drawings.

For the purpose of explanations, in order to provide a thorough understanding of one or more embodiments, numerous specific details are set forth in the following description. However, it is clear that these embodiments can also be implemented without these specific details. In other instances, in order to facilitate describing one or more embodiments, structures and devices are shown in a block diagram form.

In order to clearly illustrate the technical solution in the present invention, some of the terminology involved are defined below.

A Browser Kernel: responsible for loading and displaying webpages, and the execution part of JS, and is the core of the browser, wherein JS is a short name of Javascript.

WebApp: web applications to run on the browser.

WebApp Frame: A browser module responsible for installing, operating, uninstalling, updating, etc. a WebApp.

Further, when describing the specific embodiment in the present invention, the “target application program” can be any application program capable of networked browser, mobile QQ, etc. If not particularly described, the application program a user generally needs to network is regarded as the web application in the present invention. In addition, in order to facilitate understanding, and in the following statements, the meanings of “a local application” and “a target application program are the same.

In order to solve the problem of WebApp's direct use of other application installed on the operating system, a configuration item is added in the configuration file of the WebApp, representing expanding a JS interface and a service of using this interface to call the local application, and enabling the WebApp to use other applications installed on the operating system.

To expand WebApp applications, using other applications installed on the operating system but not limited by the WebApp frame or the terminal browser, a field is first added in the configuration file of the WebApp installation package. This field contains an expansion JS (JavaScript) function name (“a string”) and an address that responds to a request of the expansion JS function, wherein the address responding to the request of the expansion JS function can be the package name, class name or system protocol of a local application. The JS function name can forward the call to the application during the actual practice, in order to achieve expanded WebApp application functions.

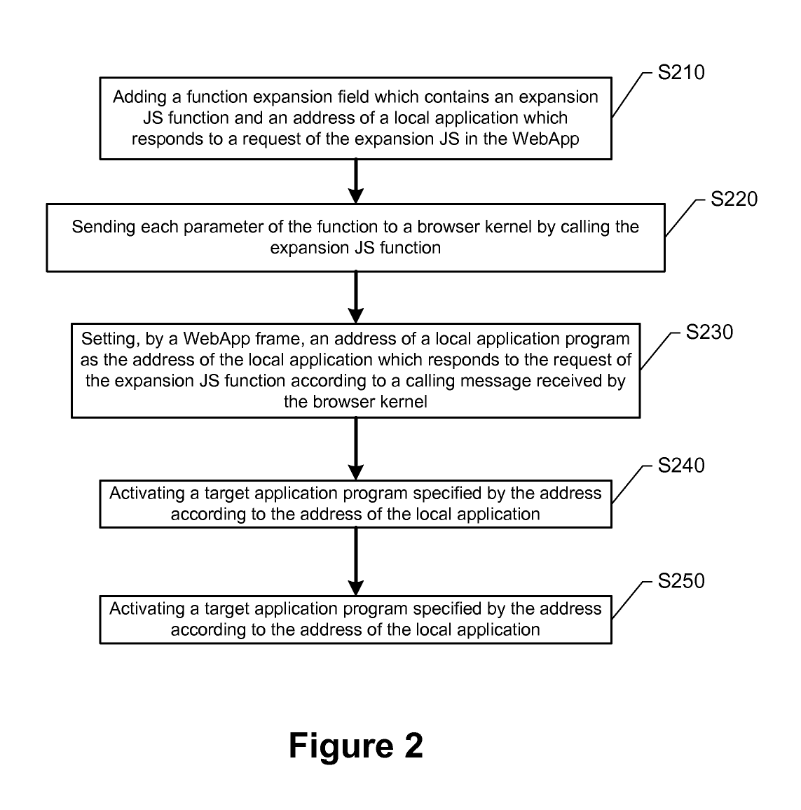

FIG. 2 shows a schematic flow diagram of a method for expanding WebApp application functions according to some embodiments. As shown in FIG. 2, the specific flowchart of expanding WebApp application functions comprises:

S210: Adding a function expansion field containing an expansion JS function and an address of a local application which responds to a request of the expansion JS function in the configuration file of the WebApp or in other manners, wherein “an address of a local application which responds to a request of the expansion JS function” can be the package name, class name, or system protocol of the local application. The class name and the system protocol processing and package name processing may be the same.

In response to an address of a local application which the expansion JS function requests, the package name of the local application (or class name, system protocol) expands the address of the local application and the expansion JS function can expand it in the configuration file or by other means

S220: sending each parameter of the expansion JS function by calling this function to a browser kernel;

S230: setting, a WebApp frame, an address of a target application program as the address of the local application which responds to the request of the expansion JS function according to a calling message received by the browser kernel (e.g.: the package name of the local application package name in response to the request of the expansion JS function); the calling message includes the parameters when JS function calls, and the execution of a target application program during the calling can be reflected or defined by the parameters;

S240: activating a target application program specified by the address according to the address of the local application;

S250: the activated target application program executing the expansion JS function according to the parameters of the expansion JS function and returning an execution result to the WebApp.

Wherein, in the step S220, the parameters are determined by the business logic, and the parameters may or may not be required. For example, in a program to adjust the screen brightness, only one parameter is needed to send to the target application program, a decimal representing a brightness percentage such as 0.65, representing 65% the brightness has been adjusted to.

According to the flowchart of FIG. 2, expanding WebApp application functions in the present invention may include adding a field of the function called by a local application program in the configuration file of the WebApp's installation package (this field can be considered as an expansion application field of the WebApp application functions), and the address of the target application program is the package name (or class name or system protocol) of the called function. In this way, it is possible to expand a JS interface and a service of using the interface to call the local application by expanding the application field in the existing WebApp application functions and enable the WebApp to use other applications installed on the operating system.

Specifically, as an example, assume that the added function expansion field is named: “ext function”, an array of strings corresponds to this field, containing two values, one for registered expansion function name and the other for a string of an address of a local application service responding to the calling of the expansion function. The registered expansion function name can be used in the Javascript (a kind of web script codes) code of the WebApp. The string of the local application service is the address responding to the request of the expansion JS function, such as the Android system, using the package name as the address, because the use of the package name can be targeted to an Activity or Service, etc. which receives and processes requests sent by the WebApp through the browser. The sending method can use the Intent technology provided by the Android platform, wherein the Activity and the Service are one of Android components: the Activity provides a service with an interface and the Service provides a service without an interface. When the Activity or the Service processes it completely, it will return the result to the WebApp. Thus, it completes a process of sending a request of the WebApp to other applications on the operating system through the browser and returning the result to the WebApp. Within the WebApp, the expansion JS function through “ex function” is the same as other common functions and can be used as a common function. When calling the expansion function, the data sent to the local application is transmitted through the parameters of this function.

The following provides a detailed description of a method for expanding WebApp application functions using the Android platform as an example. The implementations of other platforms are similar, except for the only difference in delivering messages between applications, for example, the Android platform using the Intent and IOS platform possibly using the UI (user interface) Document Interaction Controller.

This embodiment utilizes adding a configuration item in a new configuration file of the WebApp, representing expanding a JS interface and a service of using this interface to call the local application, enabling WebApp to use other applications installed on the operating system. The following describes the installation and operation stages in detail.

Installation:

During the installation of the WebApp, when parsing the configuration file of the WebApp installation package, check if there is a field expanding JS to the local application, such as a field named “ext_function.” If this field exists, retrieve the value the field corresponds to and check if the length of the string is 2. If it is 2, obtain these two strings, one for an expansion JS function name and the other for a package name of the local application.

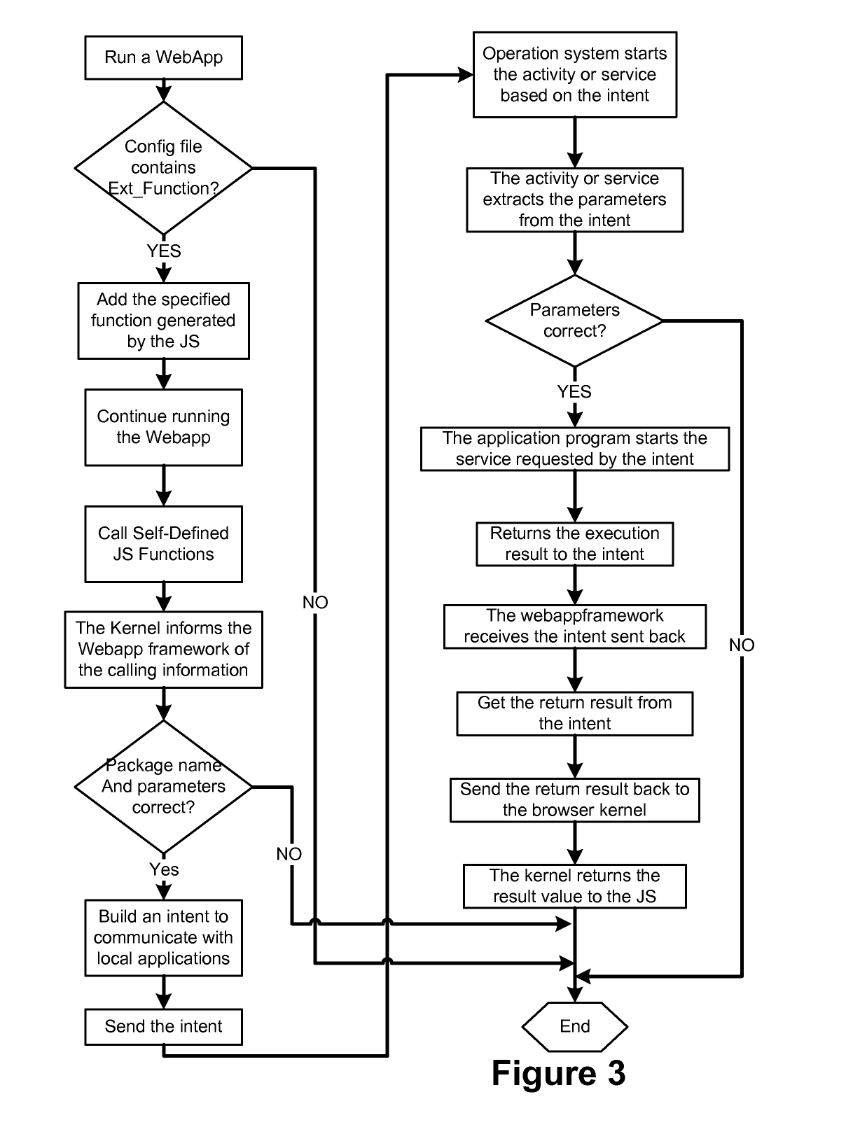

The flowchart during the running is shown in FIG. 3:

1) When opening the WebApp, test whether this configuration file of the WebApp has the “ext_function” field. If there is, a JS code is added to the WebApp, wherein the role of the JS code is to add a function in the function domain of the window and the function name is specified by the “ext_function” field. This self-defined function is given default implementation: sending each parameter of the function to the browser kernel when it is called.

Wherein, although the configuration file has the preconfigured “ext_function” field, the JS engine does not know it, and therefore a JS code is first added in the WebApp in order to notify the JS engine. The expansion function name specified by the preconfigured “ext_function” field is just a function name and a string, but the function of adding this JS code is to notify the JS engine of this JS function name.

2) When the WebApp runs and calls the JS function, the JS function will notify the browser kernel of the calling event and the parameters upon the calling.

3) The browser kernel notifies the WebApp frame of this calling message.

4) The WebApp frame assembles using the Intent provided by the Android system. That is, setting the address of the target application program as the package name and filling the parameters into the Intent upon calling the function. Wherein the Intent is like a messenger where the target application program can receive the Intent and read out the parameters. Different platforms have different interfaces when calling the target application program and the Android platform uses the startActivity function.

5) Start the Intent.

6) According to the information from the Intent, the operating system starts or activates the Activity or Service specified by the package name.

7) The Activity or the Service of the application program reads each parameter out of the Intent.

8) Based on the parameters, process the request of the Intent and perform the service requested by the Intent.

9) After the function is executed, the result is returned to the Intent.

10) The WebApp frame receives the returned Intent.

11) Take the execution result out of the Intent.

12) Return the execution result as a return value of the JS function to the WebApp.

From the above-described embodiments, the method for expanding WebApp application functions in the present invention enables the WebApp to use other applications installed on the operating system other than the browser. The aspect of greatly extending the capabilities of the WebApp is reflected in the following: the WebApp can achieve some functions by a local application that some browsers cannot offer or temporarily do not provide, because the WebApp can visit these applications by a package name and use the features they provide. For example, some of the new provisions of the HTML 5 is specified: Battery API (Application Programming Interface, an application programming interface), orientation sensor, etc., if the browser does not provide such functionality, then the WebApp can achieve these functions, because it can use other applications locally installed and possessing these functions to get the battery power and the data of the current orientation sensor.

The following examples describe the technical effects of expanding WebApp application functions.

### EXAMPLE 1

Youdao dictionary has two types of lexicons: one is a cloud lexicon and the other is a local lexicon. The so-called local lexicon refers to downloading the dictionary to a local storage, which enables quickly finding a word when using Youdao dictionary, and saving the network waiting time and the traffic of finding a word in the cloud. Generally a local lexicon is large, ranging from a few megabytes to hundreds of megabytes.

Suppose you want to achieve an English reader WebApp, the WebApp allows users to easily find the Chinese meanings some words correspond to when reading English articles. However, the current practice is to send the words users are searching for to the server and wait for the server to return the corresponding Chinese meanings. The experience of the users is very bad when the environment of the GPRS or the network flow is relatively poor, because searching for each work requires a long waiting time.

However, using the method of expanding WebApp application functions provided in the present invention, the reader WebApp uses the local Youdao dictionary; Youdao dictionary quickly finds the corresponding meaning of a word, and returns it to the WebApp by reading the local lexicon, which is displayed by the WebApp. This process does not need the traffic or network waiting thus it greatly improves the users' experience.

### EXAMPLE 2

For some readers using the WebApp, a function to adjust the screen brightness is desired. However, generally browsers do not provide a JS interface for the WebApp to use to adjust the screen brightness. But, the method for expanding WebApp application functions in the present invention enables the WebApp to call a locally installed function capable of adjusting the screen brightness, which makes the screen brightness become lower.

### EXAMPLE 3

For some browsers that cannot perfectly implement the HTML standards, if the Geolocation function is not realized, WebApps cannot obtain the user's current location information. However, using the method for expanding WebApp application functions provided in the present invention, the WebApp can obtain the user's current location information by use of the calculated information returned to the JS of the WebApp and achieve the same functionality as the Geolocation of HTML 5.

### EXAMPLE 4

The WebApp can call, send text messages, and start an application by using the method for expanding WebApp application functions provided in the present invention

According to the above specific embodiments, it is evident that using the method for expanding WebApp application functions provided in the present invention enables the WebApp to have functions of the native App.

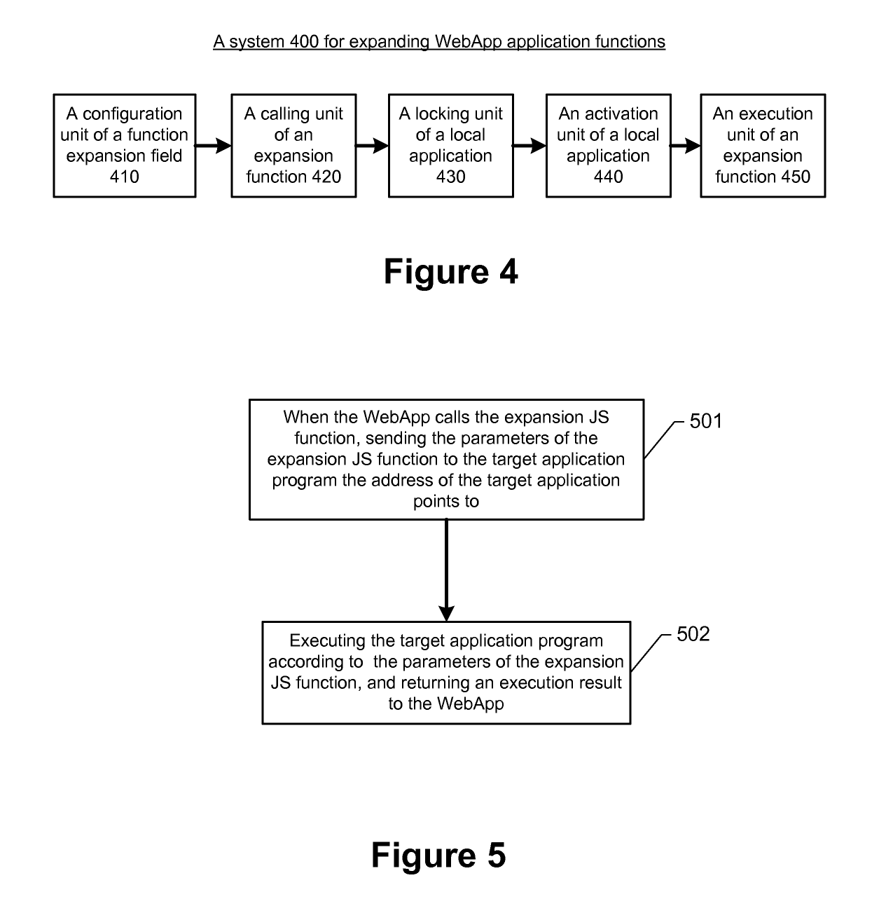

Corresponding to the above-described method for expanding WebApp application functions, the present invention also provides a system for expanding WebApp application functions. FIG. 4 is a schematic drawing of a system for expanding WebApp application functions according to some embodiments. As shown in FIG. 4, the system for expanding WebApp application functions 400 comprises a configuration unit of a function expansion field 410, a calling unit of an expansion function 420, a locking unit of a local application 430, an activation unit of a local application 440, and an execution unit of an expansion function 450.

The configuration unit of a function expansion field 410 is configured to add a function expansion field which contains an expansion JS function and an address of a local application which responds to a request of the expansion JS function in the WebApp;

The calling unit of an expansion function 420 is configured to call the expansion JS function and send each parameter of the function to a browser kernel by calling the expansion JS function;

The locking unit of a local application 430is configured to set an address of a local application program as the address of the local application which responds to the request of the expansion JS function according to a calling message received by the browser kernel;

The activation unit of a local application 440 is configured to activate a target application program specified by the address according to the address of the local application;

The execution unit of an expansion function 450 is configured by the activated target application program to execute the expansion JS function according to the parameters of the expansion JS function and return an execution result to the WebApp.

The configuration unit of the function expansion field 410 adds a function expansion field in the configuration file of the WebApp; and the configuration unit 410 sets the package name, class name or system protocol of the local application as the address of the local application in response to the request of expansion JS function.

Referring to FIG. 5, the present invention also provides a method of expanding WebApp application functions. In the method, the WebApp adds a function expansion field, wherein the function expansion field contains an expansion JS function and an address of a target application program which responds to a request of the expansion JS function; the method further comprises:

Step 501: when the WebApp calls the expansion JS function, sending the parameters of the expansion JS function to the target application program the address of the target application points to;

Step 502: Executing the target application program according to the parameters of the expansion JS function, and returning an execution result to the WebApp.

Wherein, in step 501 sending the parameters of the expansion JS function to the target application program the address of the target application points to further comprises:

By calling the expansion JS function, sending the parameters of the expansion JS function to a browser kernel;

Notifying a WebApp frame of the parameters of the expansion JS function through the browser kernel;

Sending the parameters of the expansion JS function through the WebApp frame to a target application program the address points to.

Wherein in Step 503 returning the execution result to the WebApp comprises:

Returning the execution result to the WebApp frame through the target application program;

Providing the execution result as a return value of the expansion JS function to the WebApp through the WebApp frame.

Wherein the WebApp frame uses the Intent to send the parameters of the expansion JS function to the target application program the address points to:

The target application program uses the Intent to return the execution result to the WebApp frame.

Wherein the service executed by the target application program is with or without an interface.

Wherein the function expansion field is added to the configuration file of the WebApp.

Wherein a package name, a class name, or a system protocol of the target application program is the address of the target application program.

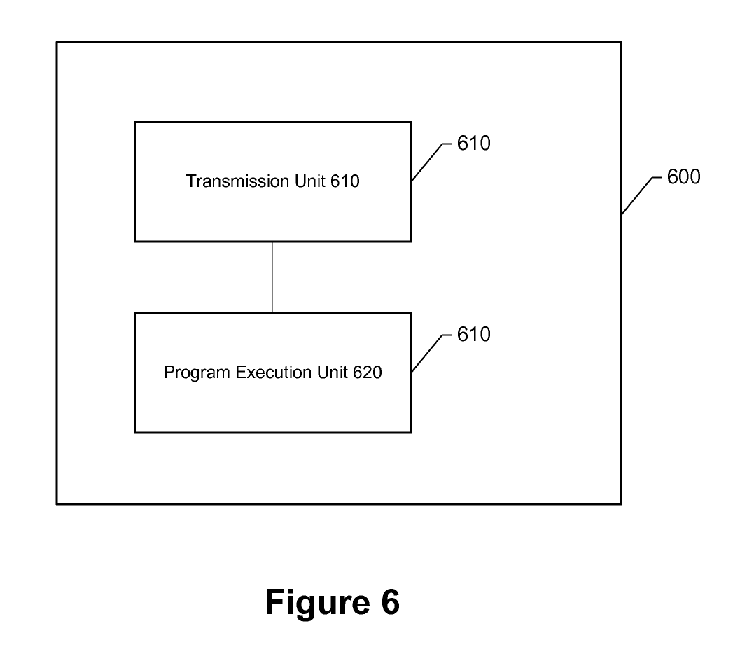

Referring to FIG. 6, the present invention also provides a system for expanding WebApp application functions, adding a function expansion field in the WebApp, wherein the function expansion field contains an expansion JS function and an address of a target application program which responds to a request of the expansion JS function. The system 600 further comprises:

A transmission unit 610, configured to send the parameters of the expansion JS function to the target application program the address of the target application program points to when the WebApp calls the expansion JS function;

A program execution unit 620, configured to execute the target application program according to the parameters of the expansion JS function and returning the execution result to the WebApp.

Wherein the transmitting unit 610 comprises:

A function calling subunit, configured to send the parameters of the expansion JS function to a browser kernel by calling the expansion JS function;

A kernel running subunit, configured to notify the WebApp frame of the parameters of the expansion JS function through the browser kernel;

A first frame running subunit, configured to send the parameters of the expansion JS function to the target application program the address points to through the WebApp frame.

Wherein the execution unit 620 further comprises:

A program execution subunit, configured to return the execution result to the WebApp frame through the target application program;

A second frame running subunit configured to provide the execution result as the return value of the expansion JS function to the WebApp through the WebApp frame.

Further, the present invention also provides a computer-readable medium that is a processor executable program code. When executed, the program code causes the processor to perform the steps of:

Adding a function expansion field in a WebApp that contains an expansion JS function and an address of a target application program which responds to a request of the expansion JS function;

When the WebApp calls the expansion JS function, sending the parameters of the expansion JS function to the target application program the address of the target application program points to;

Executing the target application program according to the parameters of the expansion JS function and returning the execution result to the WebApp.

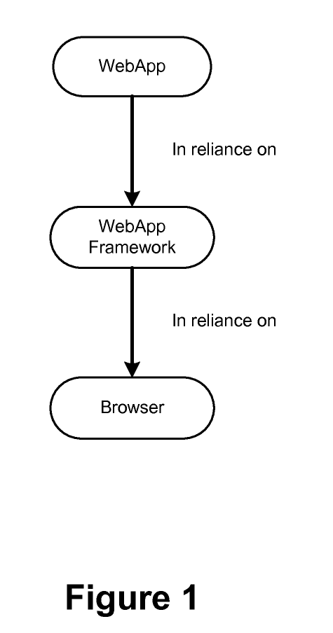

As described above with reference to FIGS. 1-6, these are the method and system for expanding WebApp application functions. However, with respect to the method and system for expanding WebApp application functions in the present invention, those skilled in the art should appreciate various modifications without departing from the present invention. Accordingly, the scope of the present invention should be determined by the contents of the claims. Those skilled in the art may understand that the technical implementation of embodiments of the present invention may be implemented by software plus a necessary universal hardware platform to achieve. Based on such understanding, the essence of the technical solution in the examples of the present invention or the part contributing to the prior art may be embodied in the form of a software product. This software product may be stored in a storage medium, such as ROM/RAM, a magnetic disk, an optical disk, etc. and include several instructions to instruct a computer device (may be a personal computer, a server, or a network equipment, etc.) to perform the various embodiments of the invention, or certain parts of the method according to the embodiment.

Each embodiment in the specification is described in a progressive manner, thus identical or similar parts between each embodiment may refer to each other. The highlight of each embodiment is the difference from the other embodiments. In particular, for the embodiments in the system, they are substantially similar to the embodiments in the method and thus are briefly described. The relevant parts may refer to those in the embodiments in the method.

Embodiments of the invention described above are not intended to limit the scope of the present invention. Any modifications made within the spirit and principles of the present invention, equivalents, and modifications are to be covered within the scope of the present invention.

1. A method for expanding WebApp application functions, comprising:
adding a function expansion field which contains an expansion JS function and an address of a local application which responds to a request of the expansion JS function in the WebApp;
sending each parameter of the expansion JS function to a browser kernel by calling the expansion JS function;
setting, by a WebApp frame, an address of a local application program as the address of the local application which responds to the request of the expansion JS function according to a calling message received by the browser kernel; and
activating a target application program according to the address of the local application;
executing, by the activated target application program, the expansion JS function according to the parameters of the expansion JS function and returning, by the activated target application program, an execution result to the WebApp.

2. The method of claim 1, wherein the service provided by the target application program includes an interface.

3. The method of claim 1, wherein the function expansion field is added in a configuration file of the WebApp.

4. The method of claim 1, wherein the calling message comprises the parameters, and the parameters define execution of a target application program during the calling.

5. The method of claim 1, wherein the address of the local application is at least one of a package name, a class name or a system protocol of the local application program.

6. A system for expanding WebApp application functions, comprising:
a configuration unit of a function expansion field, configured to add a function expansion field which contains an expansion JS function and an address of a local application which responds to a request of the expansion JS function in the WebApp;
a calling unit of an expansion function, configured to call the expansion JS function and send each parameter of the expansion JS function to a browser kernel by calling the expansion JS function;
a locking unit of a local application, configured to set an address of a local application program as the address of the local application which responds to the request of the expansion JS function according to a calling message received by the browser kernel;
an activation unit of a local application, configured to activate a target application program specified by the address according to the address of the local application; and
an execution unit of an expansion function, configured by the activated target application program to execute the expansion JS function according to the parameters of the expansion JS function and return an execution result to the WebApp.

7. The system of claim 6, wherein the configuration unit of the function expansion field is configured to add the function expansion field in a configuration file of the WebApp.

8. The system of claim 6, wherein the configuration unit of the function expansion field is configured to use at least one of a package name, a class name or a system protocol of the local application as the address of the local application in response to a request of the expansion JS function.

9. A method for expanding WebApp application functions, comprising:
adding a function expansion field in a Webapp, wherein the function expansion field contains an expansion JS function and an address of a target application which responds to a request of the expansion JS function;
when the WebApp calls the expansion JS function, sending the parameters of the expansion JS function to the target application program the address of the target application points to;
executing the target application program according to the parameters of the expansion JS function; and
returning an execution result to the WebApp.

10. The method of claim 9 wherein sending the parameters of the expansion JS function to the target application program the address of the target application points to further includes:
by calling the expansion JS function, sending the parameters of the expansion JS function to a browser kernel;
notifying a WebApp frame of the parameters of the expansion JS function through the browser kernel; and
sending the parameters of the expansion JS function through the WebApp frame to the target application program the address points to.

11. The method of claim 9, wherein returning the execution result to the WebApp includes:
returning the execution result to the WebApp frame through the target application program; and
providing the execution result as a return value of the expansion JS function to the WebApp through the WebApp frame.

12. The method of claim 10, wherein the WebApp frame sends the parameters of the JS function to the target application program the address points to by Intent; and the target application program returns the execution result to the WebApp frame using the Intent.

13. The method of claim 9, wherein the service executed by the target application includes an interface.

14. The method of claim 9, wherein the function expansion field is added to the configuration file of the WebApp installation package.

15. The method of claim 9, wherein the address of the local application program includes at least one of a package name, a class name or a system protocol of the target application program.

16. A system for expanding WebApp application functions, adding a function expansion field in the WebApp, wherein the function expansion field contains an expansion JS function and an address of a target application program in response to a request of the expansion JS function, the system comprising:
a transmission unit configured to send the parameters of the expansion JS function to the target application program the address of the target application program points to when the WebApp calls the expansion JS function; and
a program execution unit configured to execute the target application program according to the parameters of the expansion JS function and returning the execution result to the WebApp.

17. The system of claim 16, wherein the transmission unit further includes:
a function calling subunit, configured to send the parameters of the expansion JS function to a browser kernel by calling the expansion JS function;
a kernel running subunit, configured to notify the WebApp frame of the parameters of the expansion JS function through the browser kernel;
a first frame running subunit, configured to send the parameters of the expansion JS function to the target application program the address points to through the WebApp frame.

18. The system of claim 16, wherein the program execution unit includes:
a program execution subunit, configured to return the execution result to the WebApp frame through the target application program; and
a second frame running subunit configured to provide the execution result as the return value of the expansion JS function to the WebApp through the WebApp frame.

19. A non-transitory computer readable medium storing a processor executable program code, when executed, the program code causes the processor to perform the steps of:
adding a function expansion field in a WebApp that contains an expansion JS function and an address of a target application program which responds to a request of the expansion JS function;
when the WebApp calls the expansion JS function, sending the parameters of the expansion JS function to the target application program the address of the target application program points to;
executing the target application program according to the parameters of the expansion JS function; and
returning the execution result to the WebApp.
